(19) United States
(12) Patent Application Publication
(10) Pub. No.: US 2014/0114873 A1
(43) Pub. Date: Apr. 24, 2014

(54) COMPREHENSIVE EMPLOYEE LEAVE MANAGEMENT SYSTEM

(71) Applicant: HARTFORD FIRE INSURANCE COMPANY, Hartford, CT (US)

(72) Inventors: Lisa A. Contacos, Windsor Locks, CT (US); Andreas K. Karrasch, Agawam, MA (US); Sally Ann Monson, Eden Prairie, MN (US); Steven M. Ruscik, Manchester, CT (US); Norine K. Wilcox, Eagan, MN (US)

(73) Assignee: HARTFORD FIRE INSURANCE COMPANY, Hartford, CT (US)

(21) Appl. No.: 13/658,430

(22) Filed: Oct. 23, 2012

(51) Int. Cl. G06Q 10/06

(52) U.S. Cl. 705/322

(57) ABSTRACT

The invention relates, in various aspects, to systems, methods, and computer readable media suited for managing employee leave. A processor is configured to receive, from a user-accessible device, via a computer communications network, data relating to at least one claim for a first type of employee leave and also receive data to initiate at least one claim for a second type of employee leave. Thereupon, the data corresponding to the first type of employee leave and the data corresponding to the second type of employee leave are combined and reconciled. There is facilitated a determination of at least one modified leave parameter based on the combined and reconciled data, and the at least one modified leave parameter is stored in a memory storage device.

### BACKGROUND OF THE INVENTION

Employers are often in a position where they need to accommodate employee leave requests, in the context of short term and long term disability leave policies. During short term leave, an employee may typically receive a portion of his/her wages over a strictly defined time period (e.g., 6 months), at which point a long term leave policy takes over if deemed necessary. Usually, short term and long term leave are related to medical issues that may be experienced by an employee.

There are, however, a great variety of other types of leave that an employee can typically request, mandated by federal or state government. For example, the Family and Medical Leave Act (FMLA) of 1993 requires covered employers to provide job-protected and unpaid leave to employees for qualified medical and family reasons, which can include, among other things, personal or family illness, family military leave, pregnancy or adoption. State governments may offer or mandate employee leave for any of a very wide variety of reasons, including those just listed but also others.

To date, computerized leave management systems available to employers have normally addressed short term and long term disability leave in isolation from other types of leave, such as the various types of government-mandated leave just mentioned. This has created inefficiencies in processing different types of employee leave, in that multiple systems or databases may be involved that are not fully compatible with one another, or only are combinable through an expensive and time-consuming retrofit. Conventional arrangements have thus failed to provide a comprehensive and streamlined leave management system that takes into account all types of leave available to employees in a given location.

### SUMMARY OF THE INVENTION

According to one aspect, the invention relates to a computer system for employee leave management. The system comprises a processor, a memory storage device in communication with the processor, and a communications device in communication with the processor, the memory storage device and a computer communications network. The processor is configured to receive, from a user-accessible device, via the computer communications network, data relating to at least one claim for a first type of employee leave, and also receive, from a user-accessible device, via the computer communications network, data to initiate at least one claim for a second type of employee leave. Thereupon, via the processor, the data corresponding to the first type of employee leave is combined and reconciled with the data corresponding to the second type of employee leave. There is facilitated, via the processor, a determination of at least one modified leave parameter based on the combined and reconciled data, and the at least one modified leave parameter is stored in the memory storage device.

According to another aspect, the invention relates to a computer-implemented method for management of employee leave. The method includes receiving, from a user-accessible device, via a computer communications network, data relating to at least one claim for a first type of employee leave and also receiving, from a user-accessible device, via the computer communications network, data to initiate at least one claim for a second type of employee leave. Thereupon, via a processor, there is a combination and reconciliation of the data corresponding to the first type of employee leave with the data corresponding to the second type of employee leave. There is facilitated, via the processor, a determination of at least one modified leave parameter based on the combined and reconciled data. The at least one modified leave parameter is stored in a memory storage device.

According to an additional aspect, the invention relates to a non-transitory computer-readable medium, the medium having computer-readable instructions stored thereon, which instructions, when executed by a processor, cause the processor to receive, from a user-accessible device, via the computer communications network, data relating to at least one claim for a first type of employee leave, and also receive, from a user-accessible device, via the computer communications network, data to initiate at least one claim for a second type of employee leave. Thereupon, via the processor, the data corresponding to the first type of employee leave is combined and reconciled with the data corresponding to the second type of employee leave. There is facilitated, via the processor, a determination of at least one modified leave parameter based on the combined and reconciled data, and the at least one modified leave parameter is stored in a memory storage device.

### BRIEF DESCRIPTION OF THE DRAWINGS

The invention may be better understood from the following illustrative description with reference to the following drawings.

FIG. 1 is a schematic diagram of a computer network, according to an illustrative embodiment of the invention.

FIG. 2 is a schematic diagram of a computer system, according to an illustrative embodiment of the invention.

FIG. 3 schematically illustrates a system for facilitating comprehensive leave management, according to an illustrative embodiment of the invention.

FIG. 4 depicts a console screenshot generated by a server application for updating a leave management system with state leave data, according to an illustrative embodiment of the invention.

FIG. 5 depicts another console screenshot generated by a server application for updating a leave management system with state leave data, according to an illustrative embodiment of the invention.

FIG. 6 depicts yet another console screenshot generated by a server application for updating a leave management system with state leave data, according to an illustrative embodiment of the invention.

FIG. 7 depicts state leave data for use with the arrangements of FIGS. 4-6, according to an illustrative embodiment of the invention.

FIG. 8 depicts a console screenshot generated by a server application for rectifying errors received between a disability claims system and a leave management system, according to an illustrative embodiment of the invention.

FIG. 9 depicts another console screenshot generated by a server application for rectifying errors received between a disability claims system and a leave management system, according to an illustrative embodiment of the invention.

FIG. 10 depicts yet another console screenshot generated by a server application for rectifying errors received between a disability claims system and a leave management system, according to an illustrative embodiment of the invention.

FIG. 11 depicts yet another console screenshot generated by a server application for rectifying errors received between a disability claims system and a leave management system, according to an illustrative embodiment of the invention.

FIG. 12 depicts yet another console screenshot generated by a server application for rectifying errors received between a disability claims system and a leave management system, according to an illustrative embodiment of the invention.

FIG. 13 depicts yet another console screenshot generated by a server application for rectifying errors received between a disability claims system and a leave management system, according to an illustrative embodiment of the invention.

FIG. 14 depicts yet another console screenshot generated by a server application for rectifying errors received between a disability claims system and a leave management system, according to an illustrative embodiment of the invention.

FIG. 15 depicts yet another console screenshot generated by a server application for rectifying errors received between a disability claims system and a leave management system, according to an illustrative embodiment of the invention.

FIG. 16 depicts a console screenshot generated by a server application for modifying self-service group roles, according to an illustrative embodiment of the invention.

FIG. 17 depicts another console screenshot generated by a server application for modifying self-service group roles, according to an illustrative embodiment of the invention.

FIG. 18 depicts yet another console screenshot generated by a server application for modifying self-service group roles, according to an illustrative embodiment of the invention.

### DESCRIPTION OF CERTAIN ILLUSTRATIVE EMBODIMENTS

Generally, employers have policies and plans that address employee time away from work. For example, employers are required to provide workers' compensation coverage for employees who incur job-related illnesses or injuries. An employer may have policies for sick leave for relatively short periods of illness, such as up to two weeks, short term disability leave for non-occupational illnesses or injuries for periods longer than the period of sick leave and of up to generally 90 or 180 days, and long term disability plans that provide income benefits after an elimination period generally of 90 or 180 days. In addition, the Federal Family and Medical Leave Act (FMLA) applies to employers with more than 50 employees and provides eligible employees with job-protected leave for certain family or medical reasons. FMLA leave can run concurrently for the same employee with disability leave (both occupational and non-occupational conditions). Employees can also take FMLA leave for child bonding, care of a family member with a serious health condition, care of a service member injured in the line of duty, or for military exigency reasons.

Most states also have one or more leave laws with which employers must comply. Some state leave laws are similar to the FMLA in terms of qualifying leave reasons but many states provide job-protected leave for other reasons such as organ donor situations, domestic violence, victims of crime, school visitation, and volunteer firefighter leave.

Broadly contemplated herein, in accordance with at least one embodiment of the invention, are methods and arrangements for facilitating the management of employee leave inasmuch as it may derive from any of a number of different sources.

Further background information on leave management systems, which may be helpful in an understanding of one or more contexts in which at least one embodiment of the invention may be employed, may be found in co-pending U.S. patent application Ser. No. 13/025,498, published as U.S. Patent Application Publication No. US 2012/0030128 on Feb. 2, 2012

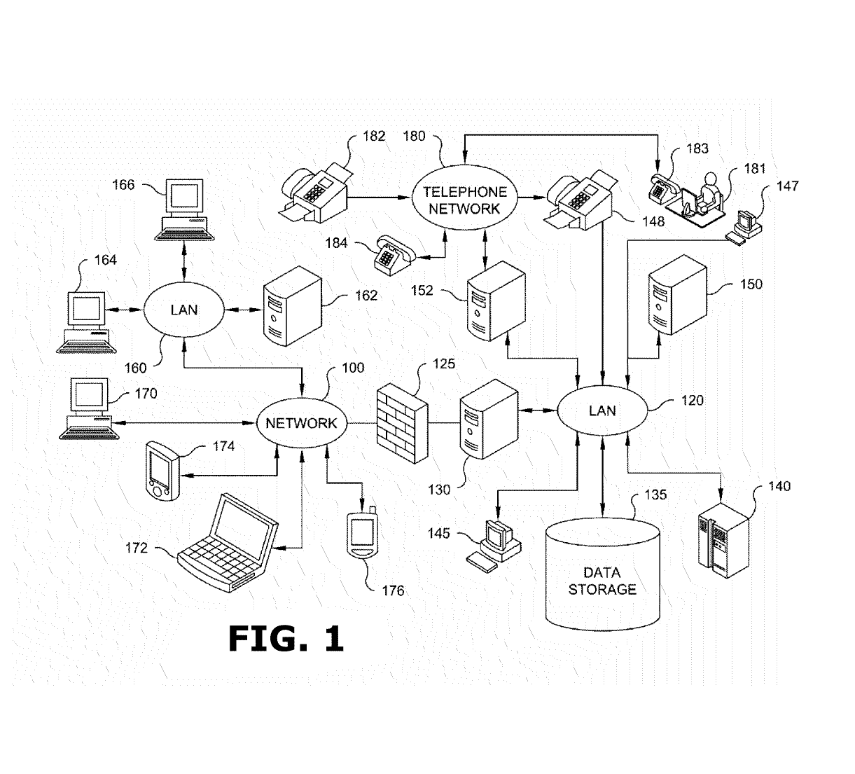

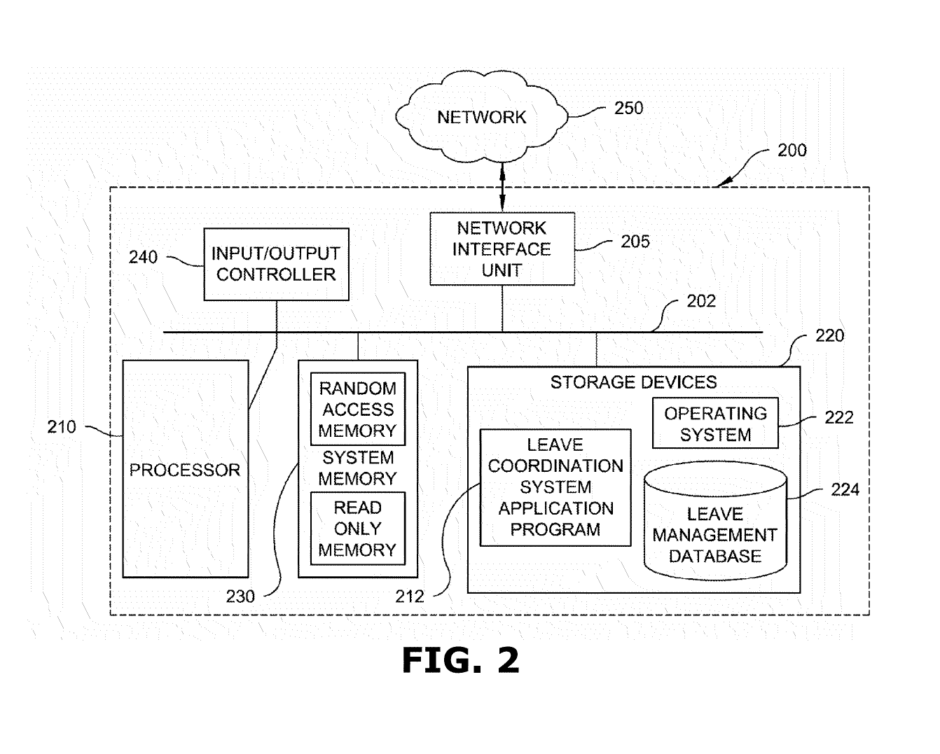

FIGS. 1 and 2 relate to examples of a computer network and computer system, respectively, which may provide a context for employing embodiments of the invention. It should be understood that the network and system shown in FIGS. 1 and 2 are provided by way of illustrative and non-restrictive example.

Referring to FIG. 1, an exemplary network configuration is shown. Network 100 connects various computer systems and devices. Network 100 may be or include any type of network, including a local area network (LAN), a wide area network (WAN), an intranet, the Internet, a public switched telephone network (PSTN) or other network. Network 100 may employ any suitable data protocols.

Various devices and networks may be in communication with network 100. In embodiments, client device 170, a desktop computer system, client device 172, a notebook computer system, client device 174, a personal digital assistant, and client device 176, a smart phone, are in communication with network 100. Client devices 170, 172, 174, 176 are merely exemplary. Local area network (LAN) 160 is an exemplary network of a business or other employer. LAN 160 has in communication therewith desktop computer systems 164, 166, and file server 162.

LAN 120 may be a network of an insurance company, by way of example. Firewall unit 125 may be configured to provide data security services with respect to systems and networks, LAN 120 and the devices in communication therewith. Firewall unit 125 may be a stand alone device including one or more processors, data storage devices, and input and output connections. Server 130 may serve as a front-end web server that formats and serves web pages to client devices running browser software. In an embodiment, a processor of server 130 may execute steps of a method of prompting users for data relating to absence events, requests for employee leave, and other data employed by comprehensive leave management systems or other systems in accordance with embodiments. In an embodiment, server 130 may function as a web front-end for another device or system, such as server 150, which may execute steps of a method of administering employee absence related programs. In an embodiment, either server 130 or server 150 may serve as a single point of contact for receiving data relating to an absence event. Mainframe computer system 140 may be a system that receives data from server 150 and performs functions related to managing and tracking absence events. Data storage device 135 may be in communication with LAN 120 and be accessible by server 150, mainframe computer system 140, web server 130 and other systems, for storage of and access to data related to administration of employee leave. Data storage device 135 may store data related to employees, employers, types of leave, rules for types of leave, and other data. Workstation 145 may be in communication via LAN 120 with data storage device 135, mainframe computer system 140, server 150, web server 130, and other devices and systems, for administrative and other functions.

In embodiments, communication between server 150 and individuals, such as employees and employers, may be via a telephone network, such as a public switched telephone network, a voice over Internet protocol network, or a combination of a PSTN and VoIP network. By way of example, a fax telephone number may be configured to receive intake data for a new leave event related to two or more categories of employee leave. Prepared forms may be available for individuals to complete with intake data. The prepared forms may serve as a structured fax format by which data may be transmitted from third party fax machine 182 via telephone network 180 to insurance company fax machine 148. Insurance company fax machine 148 may be configured to create a digital image of the received fax, e.g., in an image format such as pdf, jpg or tiff, and transmit the received digital image via LAN 120 to server 150. Server 150 may be configured to extract data from the digital image, cause the data to be stored in one or more databases, and perform analytical functions on the data. For example, server 150 may classify the data according to type of leave, such as short term disability, long-term disability or family and medical leave. If the data in the received fax omits required data, contains obvious errors, or otherwise triggers a rule requiring a response, server 150 may be configured to provide an output in the form of an image file for a responsive fax and instructions to insurance company fax machine 148 to transmit a responsive fax to a telephone number corresponding to third party fax machine 182.

In an embodiment, a third party may employ voice telephone communications to an interactive voice response system (IVR) for the submission of data. Third party voice telephone 184 may be employed by a user to reach, via telephone network 180, IVR server 152. IVR server 152 may prompt the user to provide identification information via voice or keypad, and then prompt the user to provide data corresponding to required data for submission of a new claim related to employee leave, such as employer and employee data, type of leave, and other data. IVR server 152 may communicate with server 150 via LAN 120. Server 150 may receive data from IVR server 152 in a suitable format. Server 150 may be configured to analyze data received from IVR server 152 during a telephone connection between IVR server 152 and third party telephone 184 and provide instructions for IVR server 152 to generate prompts for additional information, to indicate that data has been received, or to convey other information.

In an embodiment, a comprehensive leave management computer system may be configured to perform leave management tracking and coordination. A comprehensive leave management computer system may receive intake information and furnish the data to individual administration systems, such as workers compensation and short term disability administration systems. As an individual administration system, such as a workers compensation system, processes a claim, data regarding the claim is furnished to the comprehensive leave management computer system. The comprehensive leave management computer system may store data relating to the processing of the claim from individual administration systems. The comprehensive leave management computer system may be configured with reporting tools to provide reporting on administration of all types of leave.

In embodiments, the comprehensive leave management computer system may be configured to apply rules relating to coordination among individual leave management systems. For example, if a workers compensation claim is contested or denied, upon receipt of data indicative of the contest or denial, the comprehensive leave management computer system may transfer data relevant to the claim to a short term disability administration computer system. As workers compensation claims are generally only approved for occupational injuries, and short term disability claims are only approved for non-occupational injuries or illness, denial of a workers compensation claim as relating to a non-occupational injury indicates that the employee may have a short term disability claim. By way of further example, if a claim is being handed by the short term disability administration computer system, and a workers compensation claim for the same incident is approved, the comprehensive leave management computer system may transfer data relevant to the claim to the workers compensation system, and may provide data to the short term disability administration system to close the claim. By way of further example, if a workers compensation claim reaches a maximum duration, the comprehensive leave management computer system may transfer data relating to the claim to a long term disability administration system.

The comprehensive leave management computer system may manage communication with employees, employers, physicians and others. If data or documentation is required relating to a claim, the individual administration systems may send requests for the information to the comprehensive leave management computer system. The comprehensive leave management computer system may then conduct searches of a database maintained by the comprehensive leave management computer system. The search may include searches of databases maintained by other individual administration systems. The comprehensive leave management computer system may, if the requested information is not identified in any of the databases, formulate an automated inquiry, via any suitable method of communication, including e-mail, postal mail, fax and other methods of communication, to the employee, employer, physician or other person to obtain the requested information. The comprehensive leave management computer system may be configured to prompt an employee to place a telephone call to the employee, employer, physician or other person. Advantageously, duplicative requests for information from physicians, employees and employers may be avoided.

The comprehensive leave management computer system may also be configured to perform coordinated financial management tasks, such as running tests for accuracy as to benefits paid and owed when a single incident involves a claim in two or more individual types of leave, such as workers compensation and short term disability.

The comprehensive leave management computer system may also be configured to perform analyses of data received from individual systems to identify improper redundant payments. Such payments may be indicative of fraud. By way of example, the same employee may have received both workers compensation payments and short term disability payments for the same time period, when applicable law, regulation and/or plan contracts rule out duplicate payments.

The comprehensive leave management computer system may also be configured to apply rules to identify potential subrogation. For example, either among the questions to be answered at intake, or at a later time after submission of the claim, the comprehensive leave management computer system may include questions to identify possible responsible third parties, such as owners/operators of vehicles involved in a collision which resulted in the injury relating to a workers compensation or short term disability claim. Similarly, third parties that manufacture and maintain equipment that is involved in an injury, owners and operators of sites to which employees were assigned or dispatched at the time of an injury, may be identified either at intake or at a later time. The comprehensive leave management computer system may be configured to forward data relating to claims meeting selected criteria indicative of possible subrogation to a subrogation system or other person or system.

The comprehensive leave management computer system may be configured to administer services related to claims of multiple leave types.

The comprehensive leave management computer system may be configured to provide output signals, to store data, to print reports and otherwise to communicate data indicative of results of performance of analyses and processes. By way of example, the comprehensive leave management system may be configured to provide reports, in printed or electronic form, identifying improper duplicate payments of claims. Reports may be generated, stored in data storage devices, forwarded via e-mail, made accessible on web servers or other resources, printed in hard copy, faxed, or otherwise made available for review or stored. Reports may include data as to individual claims, individual employees, summary or complete data regarding employers, worksites, classes of employees of employers, claims suitable for subrogation, and other classifications of data. Comprehensive leave management systems may also be configured to generate instructions for payment to employees and to service providers, such as providers providing return to work services, rehabilitation services and other services; payment processing systems may be provided in communication with comprehensive leave management systems to effect payment, such as via printing and mailing of checks or by providing instructions to a bank to effect an electronic funds transfer, in accordance with instructions provided by a comprehensive leave management system.

In embodiments, a network or data processing network, such as network 100, may be employed which may include a plurality of individual networks, such as a wireless network and a landline based network, each of which may include a plurality of servers, individual workstations or personal computers. Additionally, as those skilled in the art will appreciate, one or more LANs may be included where a LAN may comprise a plurality of intelligent workstations coupled to a host processor. The networks may also include mainframe computers or servers, such as a gateway computer or application server. A gateway computer serves as a point of entry into each network. The gateway may be preferably coupled to another network by one or more communications links. The gateway may also be directly coupled to one or more workstations using a communications link. The gateway computer may also be coupled to a storage device for storing information related to employers, employees, claims and leave policies and regulations, as well as other data. Further, the gateway may be directly or indirectly coupled to one or more workstations. Those skilled in the art will appreciate that the gateway computer may be located geographically remote from the network, and similarly, the workstations may be located geographically remote from the networks and/or network servers. The client devices or workstations may connect to the wireless network using a networking protocol such as the Transmission Control Protocol/Internet Protocol (“TCP/IP”) over a number of alternative connection media, such as cellular phone, radio frequency networks, satellite networks, etc. The wireless network may connect to the gateway using a network connection a such as TCP (Transmission Control Protocol) or UDP (User Datagram Protocol) over IP, X.25, Frame Relay, ISDN (Integrated Services Digital Network), PSTN (Public Switched Telephone Network), etc.

Referring to FIG. 2, features of a system according to an embodiment are shown. An exemplary computer system 200 for use in an implementation of the invention will now be described. In computer system 200, processor 210 executes instructions contained in programs such as leave coordination system application program 212, stored in storage devices 220. Processor 210 may be a single processor, multiple processors, and/or one or more multiple core processors, by way of example. Storage devices 220 may include suitable media, such as optical or magnetic disks, fixed disks with magnetic storage (hard drives), tapes accessed by tape drives, and other storage media. Processor 210 communicates, such as through bus 202 and/or other data channels, with network interface unit 205, system memory 230, storage devices 220 and input/output controller 225. Via input/output controller 225, processor 210 may receive data from user inputs such as pointing devices, touch screens, audio inputs and keyboards, and may provide data to outputs, such as data to video drivers for formatting on displays, and data to audio devices for output as sound, and data to printers for printing in hard copy. Storage devices 220 are configured to exchange data with processor 210, and may store programs containing processor-executable instructions, and values of variables for use by such programs. Storage devices 220 may include local and network accessible mass storage devices. Storage devices 220 may include media for storing operating system 222 and mass storage devices such as leave related data storage 224 for storing data related to leave claims, such as employer data, employee data, claim data, applicable rules and values of variables for compliance with regulatory requirements, benefit data, physician data, subrogation-related data, and other data.

Leave related data storage may include data associated with Federally mandated leave, such as rules for FMLA leave, rules for leave under state law or regulation with state specific variations, such as short term disability, long term disability and workers compensation, and employer specific leave, such as sick leave, personal leave and educational leave. Leave related data storage 224 may include tables associating states, municipalities and the like, with particular types of leave mandated or available under laws and regulations of the state or municipality. Leave related data storage 224 may include data indicative of rules for each type of leave.

In an embodiment, inputs may include user interfaces, including workstations having keyboards, touch screens, pointing devices such as mice, or other user input devices, connected via networked communications to processor 210. Network interface unit 205 may communicate via network 250 with remote sources of data, such as databases maintained by other systems, including computer systems for administering a single type of leave, such as workers compensation or short term disability, employer computer systems, employee computer systems and other devices, and with systems for implementing instructions output by processor 210. Systems for implementing instructions output by processor 210 may include systems for initiating communications with employers, employees, physicians, other service providers, and others, via printing in hard copy and mailing, via postal mailing, of communications, printing to electronic files and faxing of communications, formatting and sending e-mail communication, formatting automated telephone communications, and other systems and modes of communication. Network 250 may be or include wired or wireless local area networks and wide area networks, and over communications between networks, including over the Internet. Any suitable data and communication protocols may be employed.

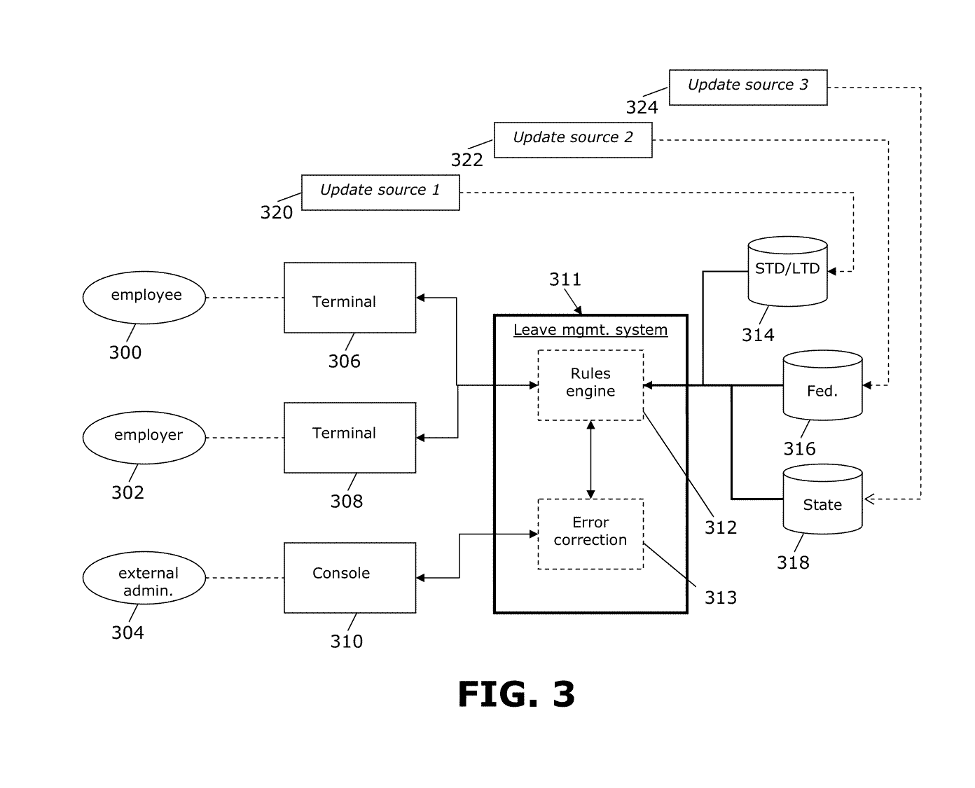

FIG. 3 schematically illustrates, in accordance with at least one embodiment of the invention, a general overview of a system for facilitating comprehensive leave management. As shown, an employee 300 of an organization has access to a terminal 306, which provides a user interface through which he/she may log in and access a leave management system 311. (As such, system 311 may be considered to be a “leave management and integration” system, where one aspect involves integrating data relative to different leave requests, possibly from different databases or other sources, and reconciling the same with respect each other so as to avoid any logistical conflict with respect to the different requests and/or to correct any errors that may arise in the course of such integration. Alternatively, the system indicated at 311 may be considered to be purely a “leave integration system”, with a dedicated function of reconciling different leave requests, while itself integrating with a “leave management system” dedicated to a more basic managerial or maintenance task of managing and monitoring logistical aspects of a prospective or ongoing employee leave.) Similarly, one or more individuals associated with the employer 302 have access to one or more of their own associated terminals 308 (and associated user interface[s]) in communication with system 311. An external or third-party administrator 304, charged with handling one or more aspects of employee leave management or with managing one or more aspects of the system 311, may also have access to one or more associated consoles 310 in communication with system 311, and particularly an error correction module 313 (in a manner to be described more fully below). For its part, the leave management system 311 itself may be integrated into an overall computer system such as that indicated at 200 in FIG. 2, or may be integrated into essentially any suitable system.

In accordance with at least one embodiment of the invention, a rules engine 312 in system 311 may consolidate and coordinate leave management data from various sources. Such sources may include, but need not be limited to, a database 314 which stores data (e.g., guidelines and parameters) regarding short-term disability (STD) and/or long-term disability (LTD) leave, as well as databases that store data regarding federal and state-specific leaves (316 and 318, respectively). Any and all of the databases 314-318 may be housed within the organization of the employee 300, or at another site (e.g., with a third-party vendor). Each database 314, 316, 318 can be updated, respectively, by update sources 320, 322, 324, that each may be associated with the employer 302, with an external administrator 304, or another source.

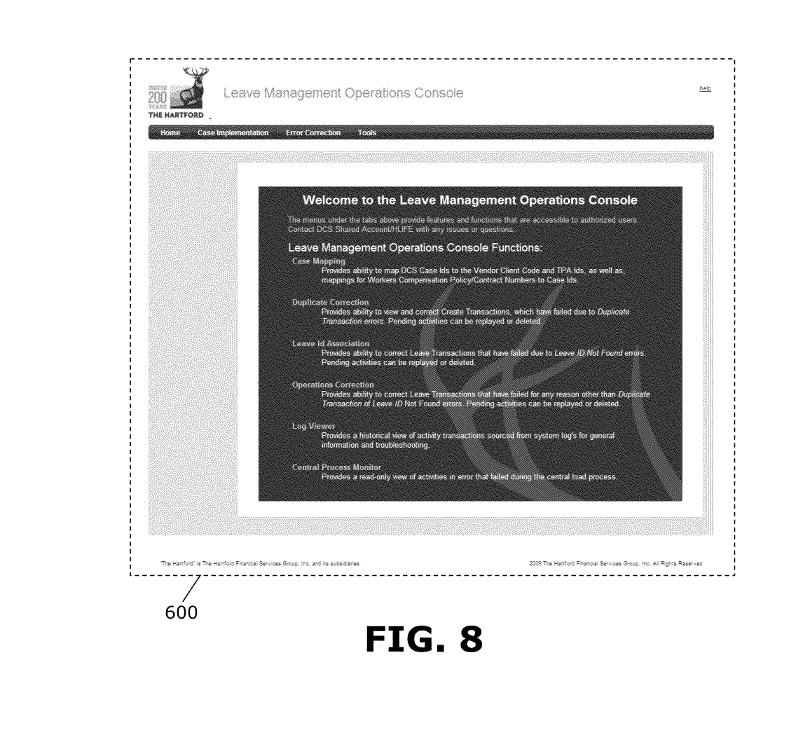

In accordance with at least one embodiment of the invention, leave management system 312 also includes an error correction module 313. Through module 313, an external administrator acting through a console 310 can review and attend to errors or discrepancies that may arise during processing after system 311 receives input, e.g., from an employee 300 and/or employer 302. As such, to the extent that the rules engine 312 integrates, consolidates and/or reconciles one type of requested leave (e.g., STD or LTD) with another (e.g., a federal or state leave), it allocates to error correction module 313 any discrepancies or errors that might require correction by an external administrator 304. Examples of such corrections are discussed in more detail herebelow with reference to FIGS. 8-18 but can include, by way of illustration, correcting a mismatch in identifiers for requested leaves as well as duplicative or overlapping records (e.g., any overlap in dates between one requested leave and another for the same employee).

As such, in accordance with at least one embodiment of the invention, and in a manner that can be appreciated from working examples presented herebelow, an incoming request for one type of leave (e.g., a federal or state-mandated leave) is matched with an existing record for another type of leave (e.g., STD or LTD). Thus, leave management system 311 can act to connect to and “talk” with a system that initiated and/or has managed the existing record, and thereupon map one or more parameters of the incoming request to one or more parameters of the existing record by way of matching the incoming request to the existing record. In the course of such mapping, discrepancies such as those noted above can be determined and then communicated by error correction module 313 to a console 310. The presentation of associated information at console 310 may be carried out in a manner such as that shown and described herein with respect to FIGS. 8-18. Generally, it can be appreciated that embodiments of the invention, as broadly contemplated herein, act to build and apply rules with respect to one or more types of leave that an existing system (e.g., a system for managing STD/LTD) may not have been configured to address.

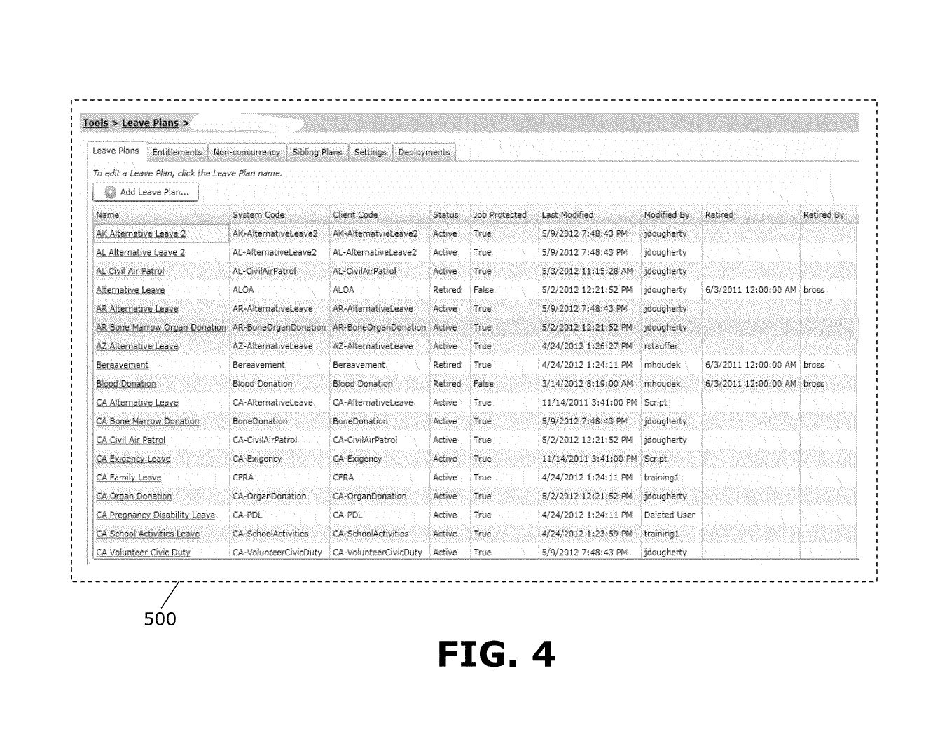

The disclosure now turns to a discussion of various actions, as illustrated in FIGS. 4-18, that may be undertaken in accordance with an arrangement such as that shown in FIG. 3, in accordance with at least one embodiment of the invention. It should be understood that the actions depicted in FIGS. 4-18 are only representative, by way of providing illustrative and non-restrictive examples of the versatility that can be afforded by a leave management system 311 as shown in FIG. 3, especially by way of handling leave management data from different sources on the part of different entities. Continued reference may be made to FIG. 3, inasmuch as the actions depicted in FIGS. 4-19 can be associated (in at least one illustrative embodiment) with elements shown in FIG. 3. (Inasmuch as elements from FIG. 3 are referred to herebelow, their corresponding reference numerals are set forth in brackets—{ }—for the purpose of easier reference.)

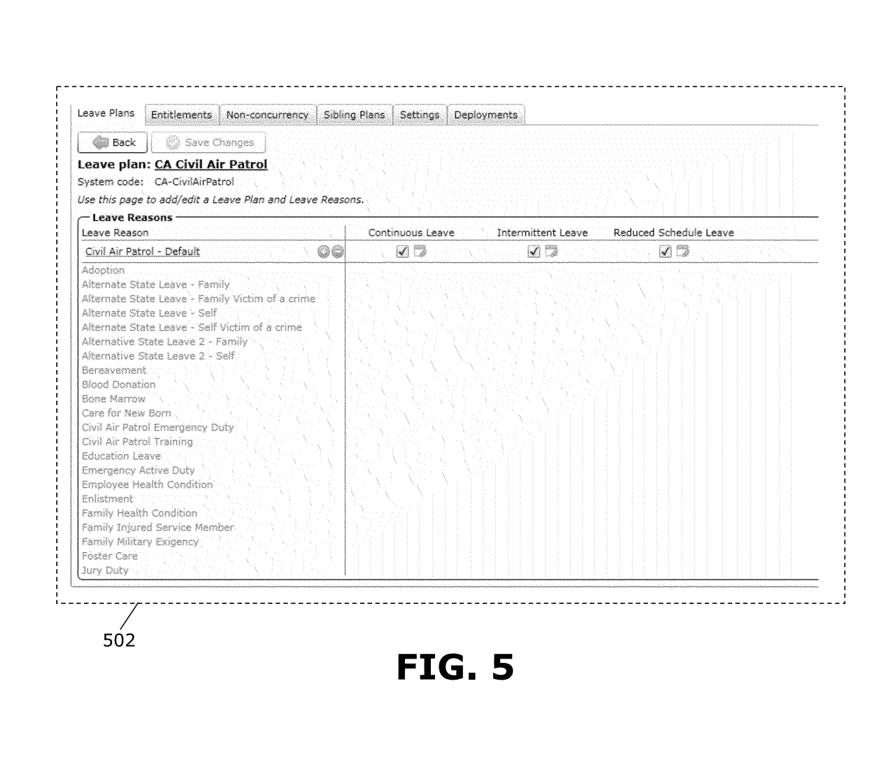

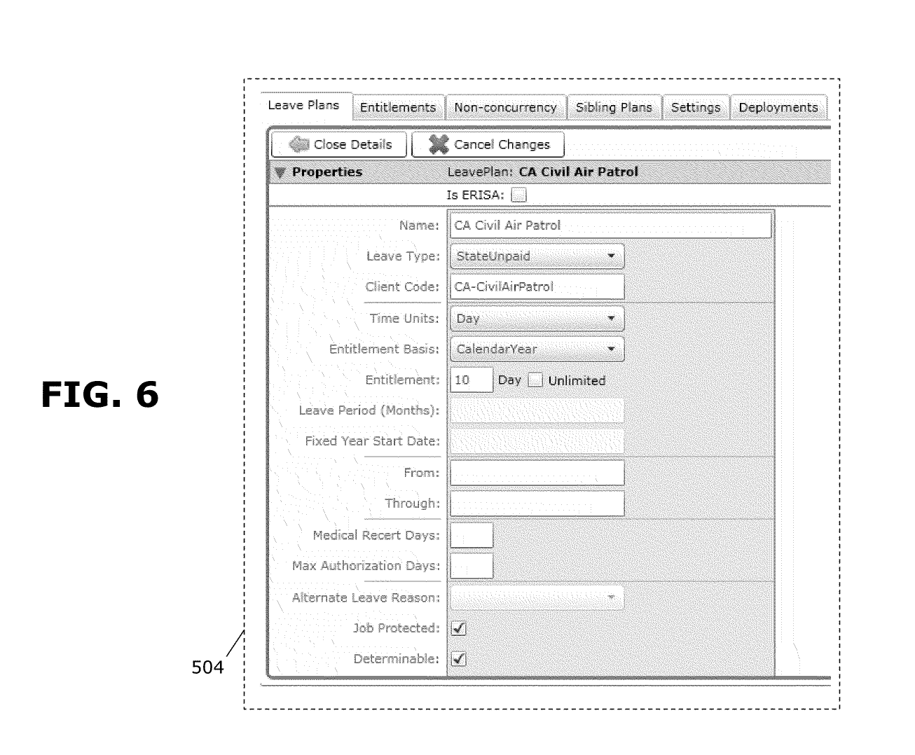

FIGS. 4-6 depict console screenshots generated by a server application for updating or configuring a leave management system with state leave data, according to an illustrative embodiment of the invention. Accordingly, an individual associated with an employer {302} or external administrator {304}, or even another individual may interact with a console (e.g., {308} or {310}) that itself is in communication with, or even constitutes an update source {324} for updating state leave data {318}. As such, a screen 500 may appear (FIG. 4) which permits an updating of any of a variety of different state leaves that may pertain to a given employer. Upon selecting a specific state leave type from screen 500, another screen 502 shown in FIG. 5 may appear that is specific to the chosen leave type, and whose parameters may be updated in accordance with any guidelines that may have changed in accordance with that leave type. (A provision can also be made for creating or entering a new leave type with a base template similar in appearance to screen 502.) The leave shown here is “Civil Air Patrol” leave in California. As shown in FIG. 6, a screen 504 may then appear in response to clicking on a button or link in screen 502 (e.g., the link “CA Civil Air Patrol”); here (in screen 504), specific parameters of the selected leave may be configured or updated.

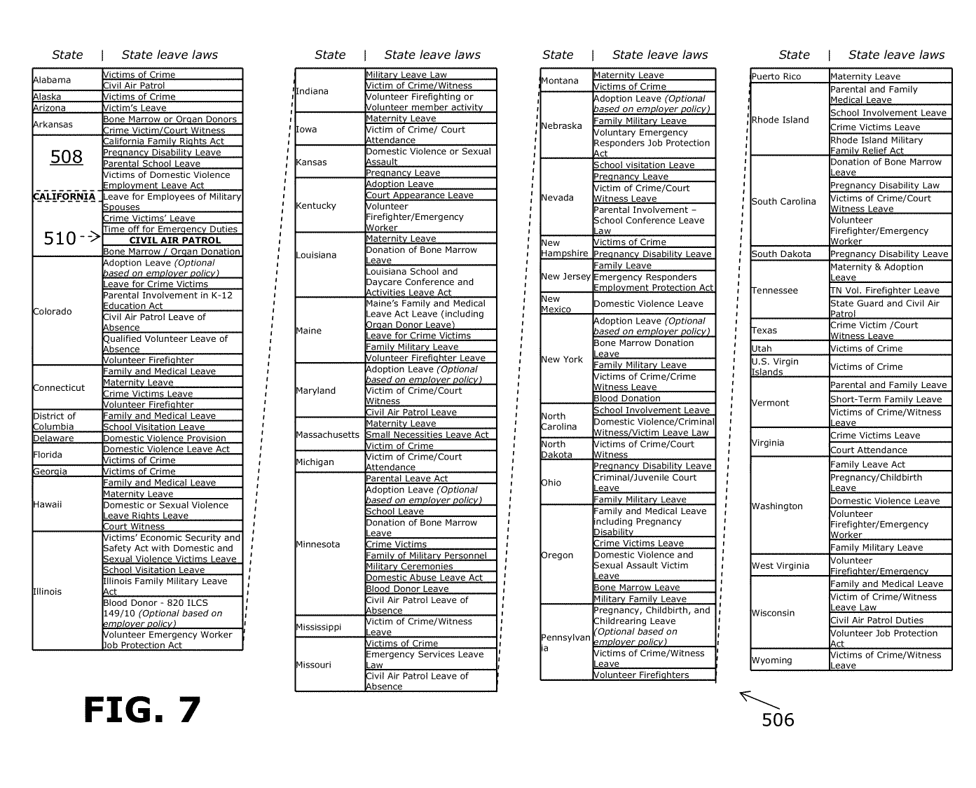

FIG. 7 depicts state leave data 506 for use with the arrangements of FIGS. 5a-5c, according to an illustrative embodiment of the invention. (The depicted list is derived from available information as of March 2012.) Such data may be contained, e.g., in database {318} and is shown here to include a breakdown by state and specific leave types (e.g., “California” [508] and “Civil Air Patrol” [510]).

FIGS. 8-15 depict console screenshots generated by a server application for rectifying errors received between a disability claims system and a leave management system, according to an illustrative embodiment of the invention. As such, it should be understood that, in accordance with embodiments of the invention, a leave management system {311} may integrate data from various sources, including a short-term and long-term disability leave database {314}, as discussed heretofore. However, it should further be understood that such STD/LTD data itself may already be processed, for the purpose of according such leave to an employee, prior to its consolidation with other data in the leave management system.

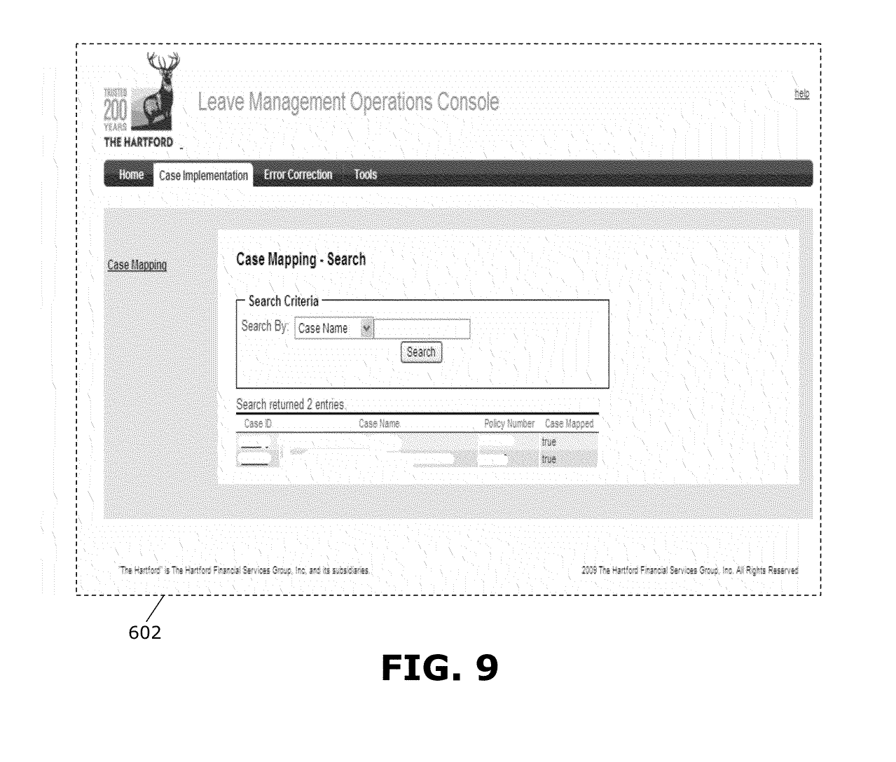

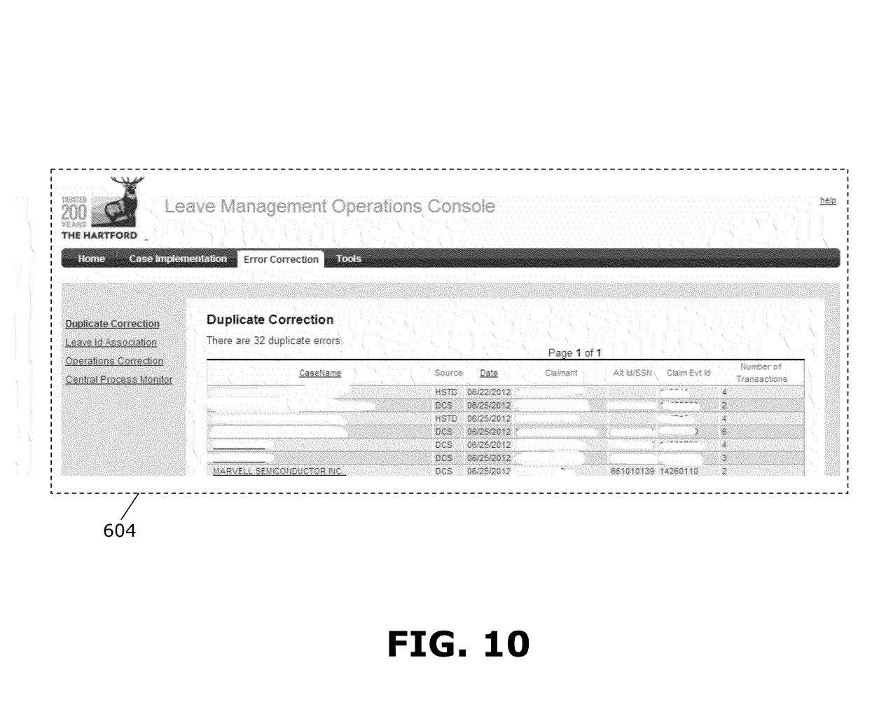

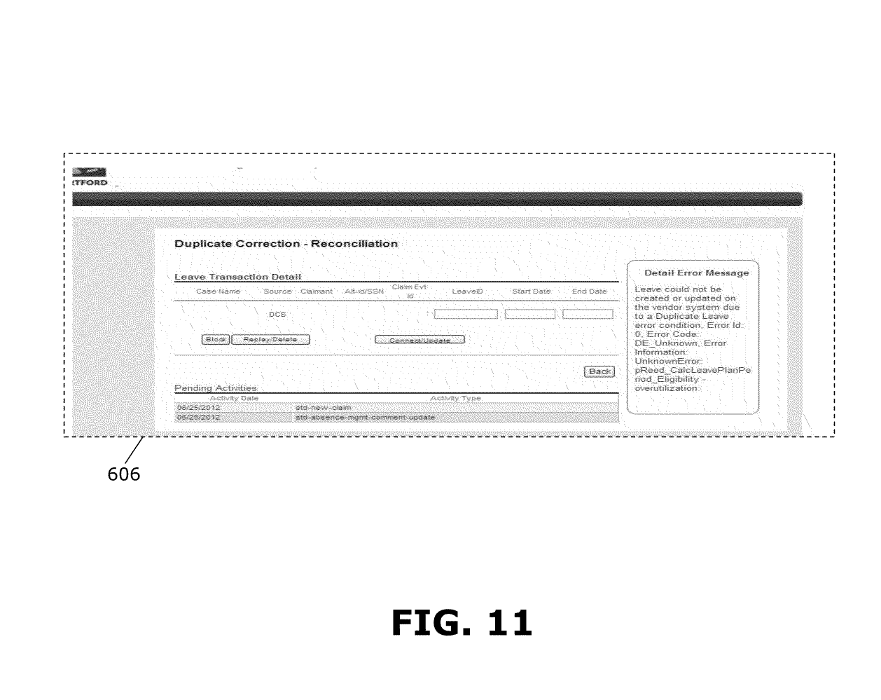

As such, in accordance with at least one embodiment of the invention, and as shown in FIG. 8, a home screen of a console (such as console {310}) may present several tabs, which can include (for instance) “case mapping” and “error correction”. As shown in FIG. 9, the “case mapping” tab can yield a view 602 for the purpose of associating a STD/LTD case with a leave case (e.g., federal or state) in leave management system {311}. A case search can be undertaken using any of several parameters, such as case name, case ID and policy number. As shown in FIG. 10, the “error correction” tab can yield a view 604 which permits different error types to be addressed, including duplicate correction (as shown). In this case, a STD claim may have been initiated while a leave already exists, and corrective options could include deleting the transaction, replaying a transaction (e.g., where an absence coordinator could change the leave to stop it from being considered a duplicate) or associating the STD event to the leave in question. A reconciliation screen 606, as shown in FIG. 11, can then be brought up upon clicking a case name, thereupon permitting any or all of the corrective actions just discussed.

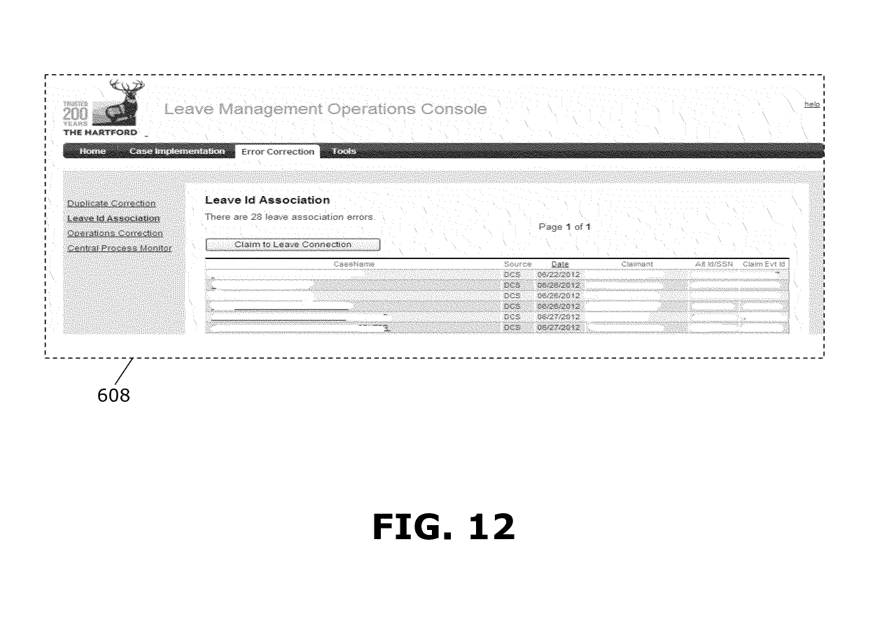

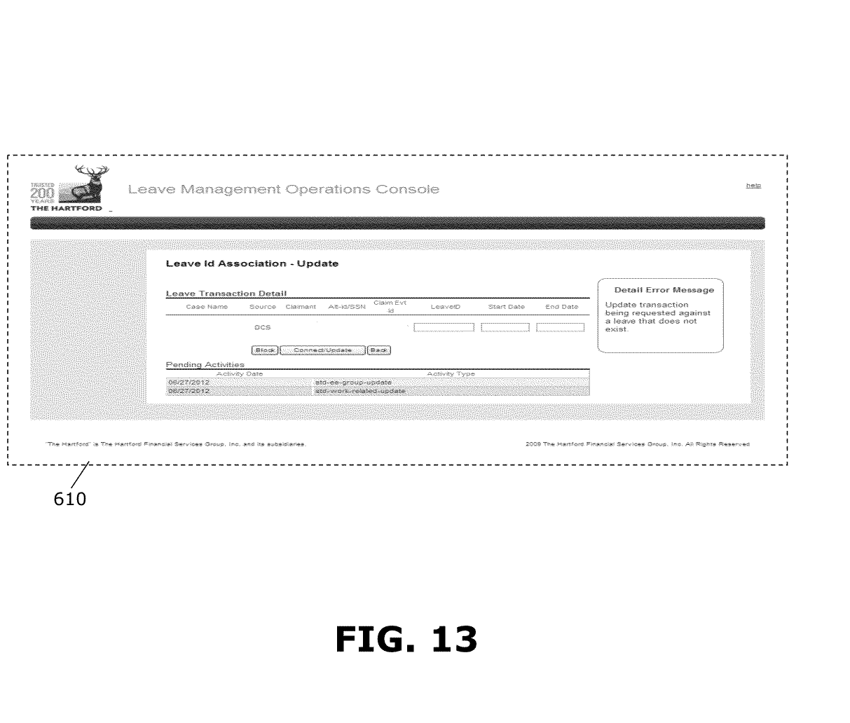

In accordance with at least one embodiment of the invention, and as shown in FIG. 12, leave ID association errors can be corrected, and a screen 608 may appear in response to choosing such an option. Such an error can arise, for instance, where a claim already exists in a disability claim system and an update is sent to leave management system {311}, but there is no leave shown there. Corrective action may thus involve, e.g., an absence coordinator adding a leave to the leave management system and resending the update transaction. When the leave is added to the leave management system, an update screen 610 (FIG. 13) can permit the addition of data such as leave ID, and leave start and end dates. (On the other hand, if no additional updates are to be sent from the disability claim system, then a delete button can be clicked, and thereafter no additional transactions will be sent on the claim to the leave management system.)

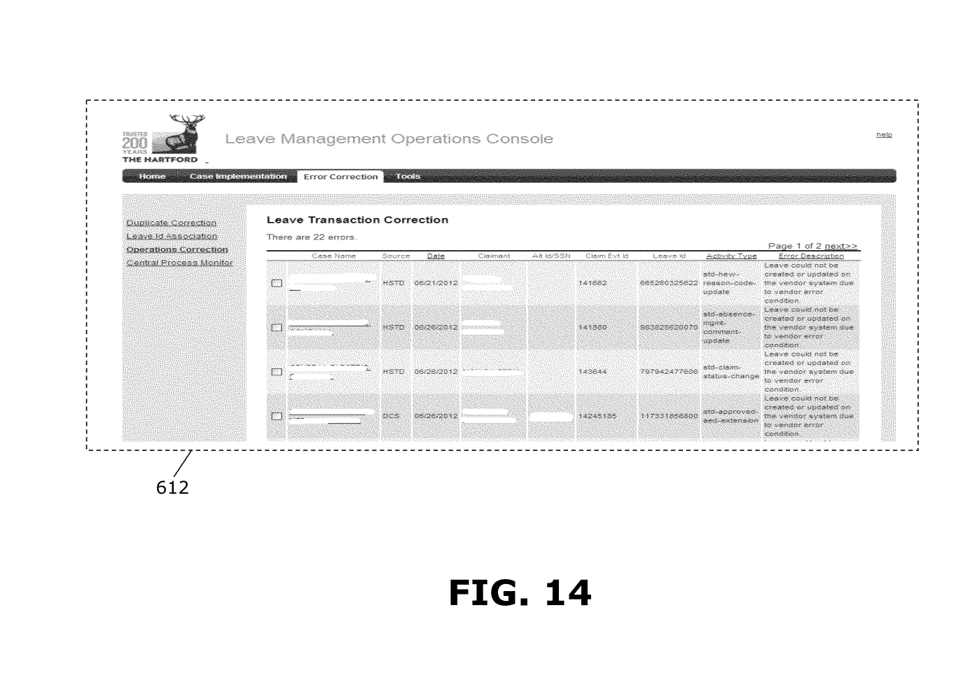

In accordance with at least one embodiment of the invention, as shown in FIG. 14, operations (e.g., leave transaction) errors can be corrected, and a screen 610 may appear in response to choosing such an option. This option can be used, e.g., by IT production support staff to fix errors that might not be impacted by business decisions. As such, once an issue is fixed, a transaction can be resent to the leave management system via a “replay” function, or it can be deleted.

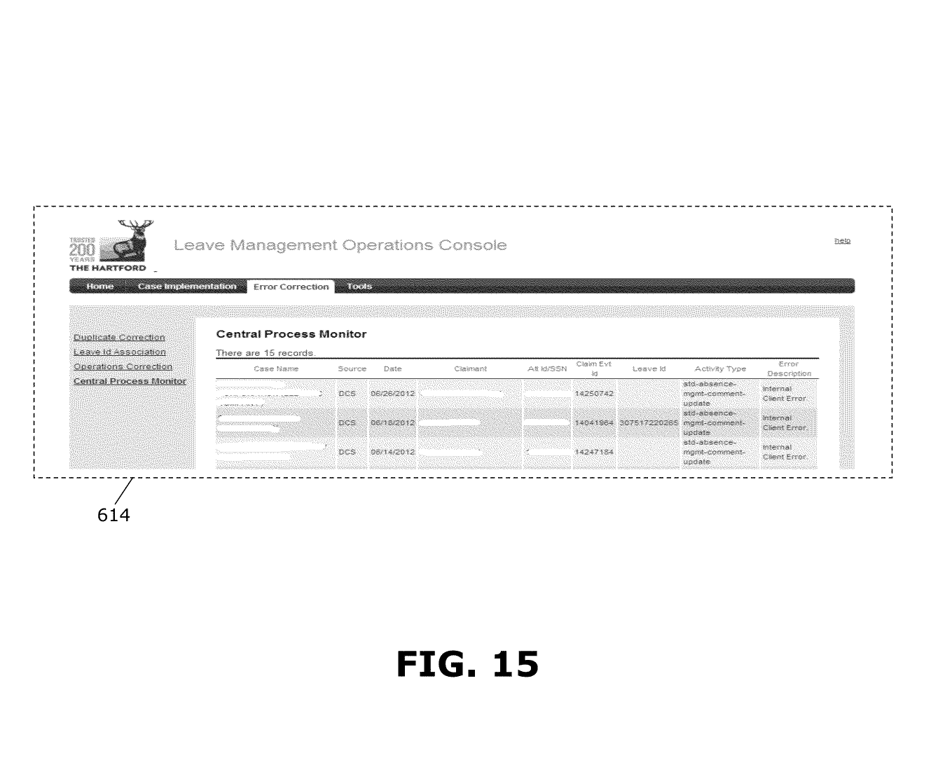

In accordance with at least one embodiment of the invention, another addressable error is in connection with a central process monitor; upon selecting such an option, a screen 614 may appear (FIG. 15). Here, an update was made with respect to a STD event but the leave management system failed to make a corresponding update. By way of example, a comment may have been created in a “notes” field with respect to a STD event that did not carry over the leave management system.

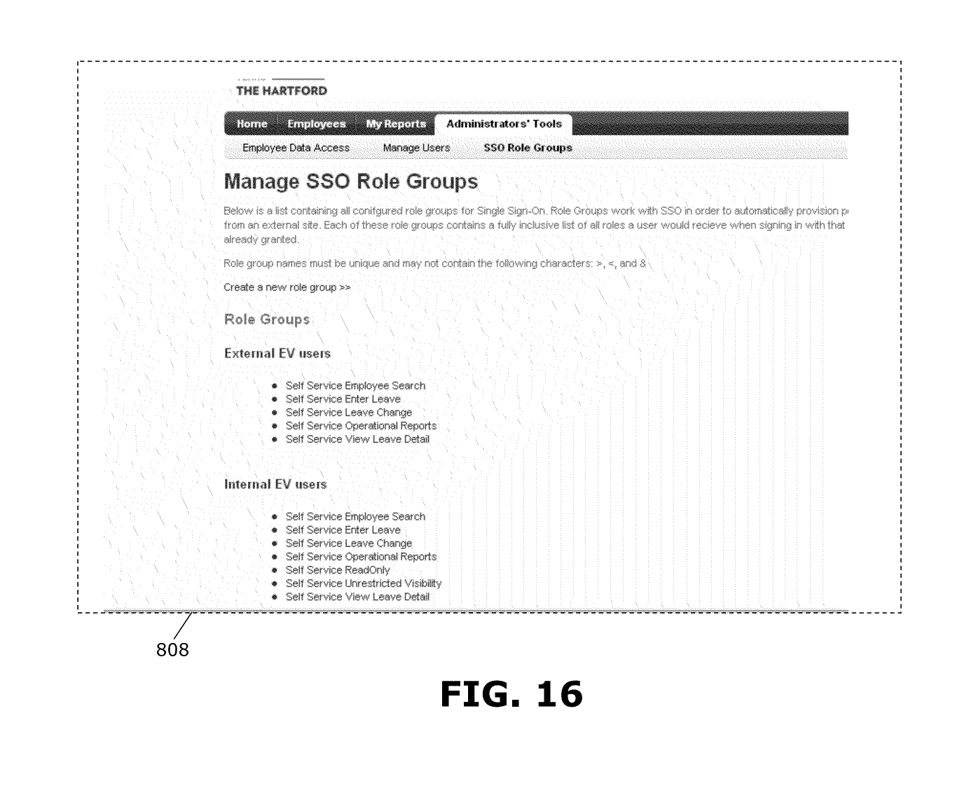

FIGS. 16-18 depict console screenshots generated by a server application for modifying self-service group roles, according to an illustrative embodiment of the invention. This permits an individual or entity to modify the capabilities and actions that are accessible to one or more individuals through a self-service console. For instance, and is shown here, an external administrator {304} can modify plan aspects related to one or more organizations (employers {302}) for which the administrator is tasked to manage plans

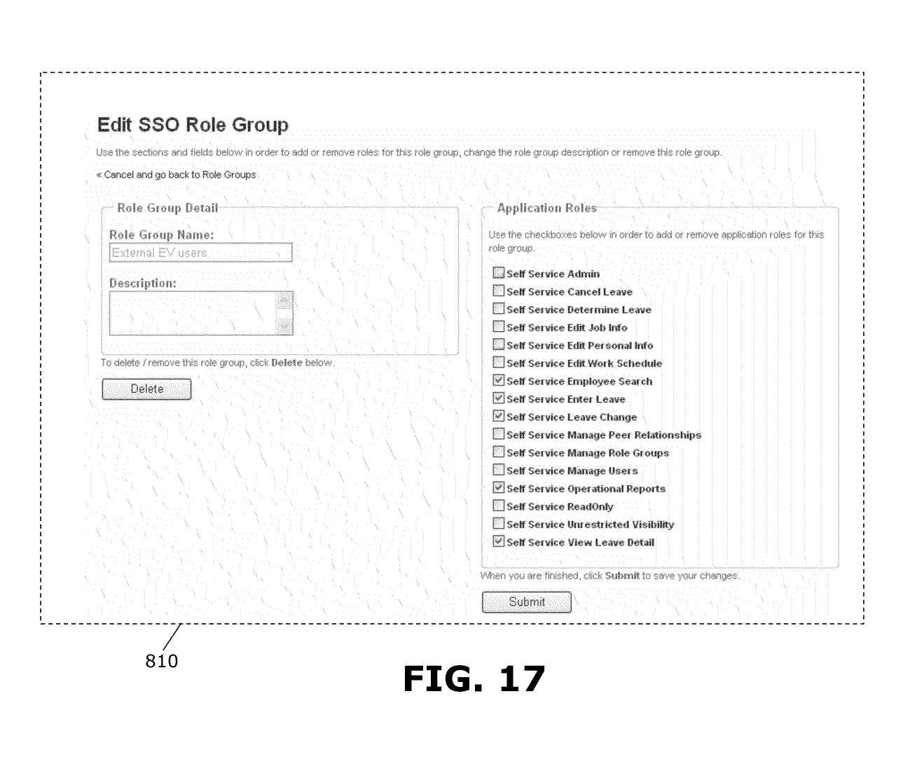

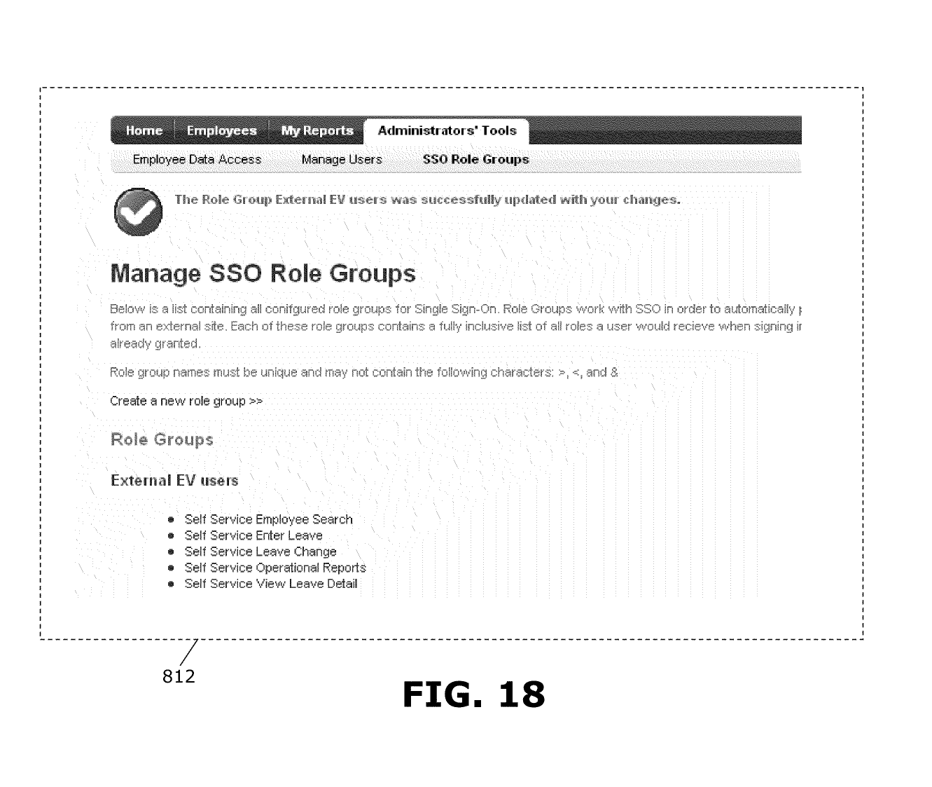

In accordance with at least one embodiment of the invention, after making a selection for “SSO role groups”, predefined external and internal SSO role groups are shown in a screen 808 (FIG. 16). (SSO [single sign-on] role groups, by way of illustrative example, can relate to predefined groups residing within the context of an employer each having a predetermined level or set of permissions for accessing a leave management system or aspects thereof.) Upon clicking a particular group for modification (e.g., “External EV users”, referring to “Employer View”), the group opened in an edit screen 810 (FIG. 17). One or more application roles can then be selected or deselected for the group by clicking on a corresponding box in the “Application Roles” section. As shown in FIG. 18, a screen 812 provides an acknowledgement a successful change (e.g., as shown here with a check mark), and the user may then follow with a verification step

It should be understood that the examples discussed and illustrated herein with respect to FIGS. 5-18 are but merely illustrative of a wide variety of possibilities for implementing a comprehensive leave management system in accordance with at least one embodiment of the invention. For instance, a great variety of other functions and capabilities can be availed to an employee, employer or external administrator alike. Such functions an capabilities can include, but need not be limited to, an employee input console (for requesting leave), an arrangement for setting up and maintaining a wide spectrum of administrative permissions (e.g., with respect to different individuals in an employing organization or a third-party leave administration vendor), and an arrangement for an employer to generate transactional reports.

The invention may be embodied in other specific forms without departing from the spirit or essential characteristics thereof. The forgoing embodiments are therefore to be considered in all respects illustrative, rather than limiting of the invention.

What is claimed is:

1. A computer system for employee leave management, comprising:
a processor;
a memory storage device in communication with the processor; and
a communications device in communication with the processor, the memory storage device and a computer communications network;
wherein the processor is configured to:
receive, from a user-accessible device, via the computer communications network, data relating to at least one claim for a first type of employee leave;
receive, from a user-accessible device, via the computer communications network, data to initiate at least one claim for a second type of employee leave;
thereupon, via the processor, combine and reconcile the data corresponding to the first type of employee leave with the data corresponding to the second type of employee leave;
facilitate, via the processor, a determination of at least one modified leave parameter based on the combined and reconciled data; and
store the at least one modified leave parameter in the memory storage device.

2. The computer system according to claim 1, wherein the first type of employee leave comprises at least one member selected from the group consisting of: short-term disability leave; and long-term disability leave.

3. The computer system according to claim 2, wherein the second type of employee leave comprises at least one member selected from the group consisting of: federal leave and state-specific leave.

4. The computer system according to claim 1, wherein the second type of employee leave comprises at least one member selected from the group consisting of: federal leave and state-specific leave.

5. The computer system according to claim 1, wherein the processor is configured to receive, from a user-accessible device, via the computer communications network, data corresponding to an employer approval of at least one of: the at least one claim for a first type of employee leave; and the at least one claim for a second type of employee leave.

6. The computer system according to claim 1, wherein the processor is configured to:
receive, from a user-accessible device, via the computer communications network, data corresponding to at least one configuration parameter related to each of the first type of employee leave and the second type of employee leave;
map at least one configuration parameter related to the second type of employee leave to at least one configuration parameter related to the first type of employee leave;
determine at least one discrepancy corresponding to the mapped configuration parameters;
transmit, to a user-accessible device, via the computer communications network, data with respect to the at least one discrepancy; and
receive, from a user-accessible device, via the computer communications network, corrective data with respect to the at least one discrepancy.

7. The computer system according to claim 6, wherein the processor is configured to:
present the data with respect to the at least one discrepancy at a user-accessible console; and
provide an interface, at the user-accessible console, for correcting the at least one discrepancy.

8. The computer system according to claim 1, wherein the processor is configured to receive, from a user-accessible device, via the computer communications network, data corresponding to a correction to the combined and reconciled data.

9. The computer system according to claim 1, wherein the processor is configured to transmit, to a user-accessible device, via the computer communications network, data corresponding to at least one error relating to the combined and reconciled data.

10. The computer system according to claim 1, wherein the processor is configured to:
receive, from a user-accessible device, via the computer communications network, data in the nature of a request to generate a report relative to the combined and reconciled data; and
thereupon transmit, to a user-accessible device, via the computer communications network, data in the nature of an instruction to generate a report relative to the combined and reconciled data.

11. The computer system according to claim 1, wherein the processor is configured to receive, from a user-accessible device, via the computer communications network, data in the nature of a request to manage data processing capabilities of at least one user relative to at least one of the first and second types of employee leave.

12. A computer-implemented method for management of employee leave, comprising:
receiving, from a user-accessible device, via a computer communications network, data relating to at least one claim for a first type of employee leave;
receiving, from a user-accessible device, via the computer communications network, data to initiate at least one claim for a second type of employee leave;
thereupon, via a processor, combining and reconciling the data corresponding to the first type of employee leave with the data corresponding to the second type of employee leave;
facilitating, via the processor, a determination of at least one modified leave parameter based on the combined and reconciled data; and
storing the at least one modified leave parameter in a memory storage device.

13. The method according to claim 12, wherein the first type of employee leave comprises at least one member selected from the group consisting of: short-term disability leave; and long-term disability leave.

14. The method according to claim 13, wherein the second type of employee leave comprises at least one member selected from the group consisting of: federal leave and state-specific leave.

15. The method according to claim 12, wherein:
said receiving steps comprises receiving, from a user-accessible device, via the computer communications network, data corresponding to at least one configuration parameter related to each of the first type of employee leave and the second type of employee leave;
said combining and reconciling comprises mapping at least one configuration parameter related to the second type of employee leave to at least one configuration parameter related to the first type of employee leave; and
said facilitating comprises:
determining at least one discrepancy corresponding to the mapped configuration parameters;
transmitting, to a user-accessible device, via the computer communications network, data with respect to the at least one discrepancy; and
receiving, from a user-accessible device, via the computer communications network, corrective data with respect to the at least one discrepancy.

16. The method according to claim 15, wherein said facilitating further comprises:
presenting the data with respect to the at least one discrepancy at a user-accessible console; and
providing an interface, at the user-accessible console, for correcting the at least one discrepancy.

17. A non-transitory computer-readable medium, the medium having computer-readable instructions stored thereon, which instructions, when executed by a processor, cause the processor to:
receive, from a user-accessible device, via a computer communications network, data relating to at least one claim for a first type of employee leave;
receive, from a user-accessible device, via the computer communications network, data to initiate at least one claim for a second type of employee leave;
thereupon, via the processor, combine and reconcile the data corresponding to the first type of employee leave with the data corresponding to the second type of employee leave;
facilitate, via the processor, a determination of at least one modified leave parameter based on the combined and reconciled data; and
store the at least one modified leave parameter in a memory storage device.

18. The computer-readable medium system according to claim 17, wherein:
the first type of employee leave comprises at least one member selected from the group consisting of: short-term disability leave; and long-term disability leave; and
the second type of employee leave comprises at least one member selected from the group consisting of: federal leave and state-specific leave.

19. The computer-readable medium according to claim 17, the processor is caused to:
receive, from a user-accessible device, via the computer communications network, data corresponding to at least one configuration parameter related to each of the first type of employee leave and the second type of employee leave;
map at least one configuration parameter related to the second type of employee leave to at least one configuration parameter related to the first type of employee leave;
determine at least one discrepancy corresponding to the mapped configuration parameters;
transmit, to a user-accessible device, via the computer communications network, data with respect to the at least one discrepancy; and
receive, from a user-accessible device, via the computer communications network, corrective data with respect to the at least one discrepancy.

20. The computer-readable medium according to claim 19, wherein the processor is caused to:
present the data with respect to the at least one discrepancy at a user-accessible console; and
provide an interface, at the user-accessible console, for correcting the at least one discrepancy.
